(19) United States
(12) Patent Application Publication
(10) Pub. No.: US 2013/0082430 A1
(43) Pub. Date: Apr. 4, 2013

(54) SUPPORT STRUCTURE TO MAKE INSTRUMENTS FOR DENTAL PROSTHESIS

(71) Applicant: Vincenzo Cuiuli, Majano (IT)

(72) Inventor: Vincenzo Cuiuli, Majano (IT)

(73) Assignee: PPM S.A.S., Pagnacco (IT)

(21) Appl. No.: 13/641,466

(22) PCT Filed: Apr. 12, 2011
(86) PCT No.: PCT/IT11/00111

§ 371 Date: Dec. 2, 2012

(30) Foreign Application Priority Data
Apr. 16, 2010 (IT) VI2010A000108

(51) Int. Cl. B23Q 3/00

(52) U.S. Cl. CPC B23Q 3/00
USPC 269/287

(57) ABSTRACT

Support structure to make instruments for dental prosthesis, comprising a base element (10), and a plurality of upper elements (20, 30, 50) which can be coupled through guide means (11, 12) with said base element (10) and positioning means (21, 31, 51) placed on each of said upper elements (20, 30, 50), one or more handmade articles need to make a dental prosthesis being assembled upon the instruments (A, V, P) resulting from said coupling. Said guide means include at least two first rods (11), positioned in respective first seats (19a) made along a perimeter portion of said base element (10), and at least one third rod (12) positioned in at least a respective second seat (19b) which is located substantially adjacent or opposite to the minimum perimeter portion of said base element (10) included between said first seats (19a).

The present invention concerns a support structure to make instruments for dental prosthesis.

Even more particularly, the invention concerns a support structure to make instruments for dental prosthesis, which through elements interchange allows to check and control all the stages of study, design and development of a dental prosthesis.

As it is well known, in the traditional technique the manufacturing of any dental prosthetic handmade preliminarily provides the stages:
A. case assessment in relation with the requirement formulated by the odontist about clinician's prescription;
B. risks assessment and analysis, with the aim of minimizing them if it is not possible to completely eliminate them;
C. planning of the work stages.

The first practical approach to the handmade, after the models arranged have been mounted on the dental articulator is the analysis modelling. With this the odontist has everything which firstly allows him to preliminarily assess the sample of the handmade and, subsequently, control all the stages of manufacturing of the prosthetic device, make possible changes necessary during working, clearly and precisely plan, from the very first working cycles, the path to reach the finished prosthesis so that it meets the fundamental principles of functionality and aesthetics, avoiding to the patient problems of mastication, equilibrium and possible interests of the facial nerves and musculature.

The analysis modelling constitutes the prototype of the work that will be delivered to the patient, the starting point and at the same time the trace that connects the project with the real prosthesis that will be installed in patient's mouth. The physical technical design, resulted from the modelling, provides to the odontist clear indications on the feasibility of successfully carrying out a given work, it indicates him the management of spaces and volumes, it allows him to define variables that might affect the prosthetic restoration. Moreover, such a modelling suggests from the beginning to the odontist whether the request of the technical prosthetic device object of the clinic prescription can be brought to fruition or not. It is at this crucial stage of the design that the odontist determines the type of prosthesis to be made, the various aspects of prosthetic restoration, such as the occlusal scheme, length, slope, shape, occlusion in statics and freedom in dynamics of the eccentric movements. Once the study modelling has been performed, it is necessary to store all the data collected so far and transferred them to the subsequent stages.

An aid to the modelling is given by the following tools: dental articulator, verticulator, silicone mask, mitten and positioning element.

The articulator is the most important tool inside the dental laboratory, i.e. that one allowing to simulate the mastication movements. Its accuracy and ergonomics are the main features necessary to achieve a work suitable to fulfil the clinical prescription and patient's comfort. What the odontist makes with the aid of the articulator must then be mounted on a patient, so it is necessary the masticatory movements are simulated. Once made the model, it must be mounted on a dental verticulator, necessary to make a negative of the wax model, so-called mask. By these means, according to the known technique, a corresponding metallic structure is realized. The mitten is the tool where the plaster mould, metallic structure and mask are positioned, at the final stage, wherein, photo polymerizing or self hardening resins, forming by hardening the outer surface of the final dental prosthesis, are injected into the cavity formed between the metallic structure and the corresponding mask.

These solutions implemented so far present the drawback of forcing the odontist to very delicate and arduous work stages.

In the solutions implemented so far, moreover, there is no guarantee that the final product is qualitatively and aesthetically perfect, obliging to focus much more on the functionality than the aesthetics, critical aspect in this type of prosthesis, as well as there are economic and time disadvantages. Indeed, the plaster mould and mask are moved from one instrument to another with a high possibility of errors in positioning and detecting, and making the definitive prosthesis too.

The patent EP1226792, on behalf of the applicant, describes an equipment for making dental prosthesis, including a base element into which a plaster mould of the teeth, onto which the prosthesis can be mounted, is suitable to be mounted, guide means arranged to selectively and alternatively couple with the base element a positioning element suitable to position at least one reference element into the plaster mould, a support element suitable to be opposed to the base element in order to get at least one mask having the negative cast of the prosthesis, or a shell element for polymerizing the resins that form the outer part of the prosthesis. The same patent EP1226792 discloses a method for making dental prostheses comprising a first stage in which a plaster casting inside the cast of the teeth on which the prosthesis has to be made is performed, and a subsequent insertion of reference pins into the plaster casting, a second stage in which at least one mask bearing the cast of the prosthesis is made, and a third stage in which the injection of resin inside the mask, and their subsequent hardening, occur, wherein the stages are suitable to be implemented by a base element with which a positioning element, suitable to insert the reference pins into the plaster casting, a support element suitable to support the material for making the mask and a shell element, suitable to contain the plaster mould and mask, are alternately associated.

This solution has the limit of not providing a full range of tools necessary for the working of a prosthesis, but only a very small number. This still implies all the risks deriving from the handling of the handmade articles from an accessory to another, such as silicone breakage, the imprecision in positioning the prosthesis onto the support structures, loss of time and absolutely necessary odontist's concentration due to the delicacy of his work.

There is, therefore, the need to provide for the use of a more efficient system, which overcomes the drawbacks of the prior art and minimizes the number of movements of the handmade articles from an instrument to another, simplifies as much as possible the working stages, allows to concentrate much more on the aesthetics of the prosthetic handmade article and is economically advantageous.

In this general context, the proposed solution in accordance with the present invention introduces, namely a structure to make instruments for dental prostheses.

Therefore, it is purpose of the present invention to create a support structure to make instruments for dental prosthesis, which allows in particular to eliminate the movements of the models from an instrument to another. Another purpose of the present invention is to simplify as much as possible the working stages, thereby simultaneously increasing the accuracy in positioning the prosthesis onto the support structures.

Further purpose of the invention is to reduce the risks of breakages of the semifinished articles during the various working stages, allowing the user to concentrate on the aesthetics and get an economic advantage over the known art as well.

These and other purposes are achieved by the support structure to make instruments for dental prosthesis according to the enclosed claim 1; other technical features of detail are set forth in the dependent claims.

The present invention will now be described, with the aid of the accompanying drawings, by illustrative, but not limiting, way in one of the many embodiments that highlight the support structure to make instruments for dental prostheses according to the invention.

In particular, the system according to the present invention comprises the following elements:

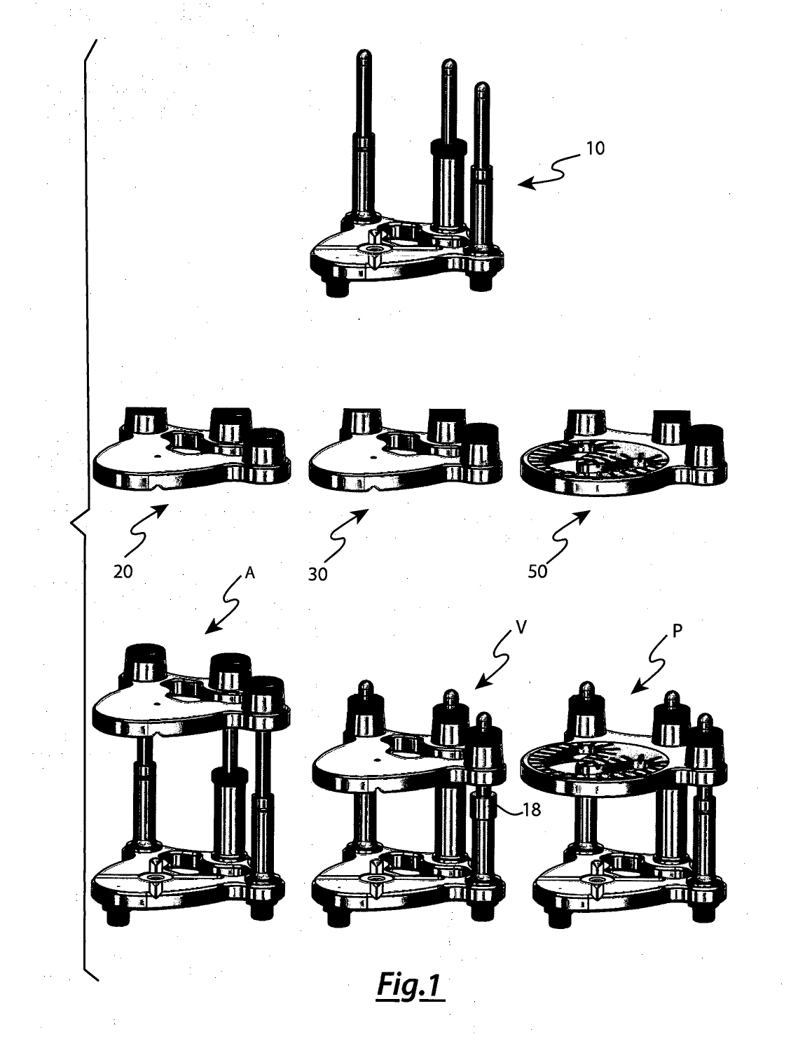

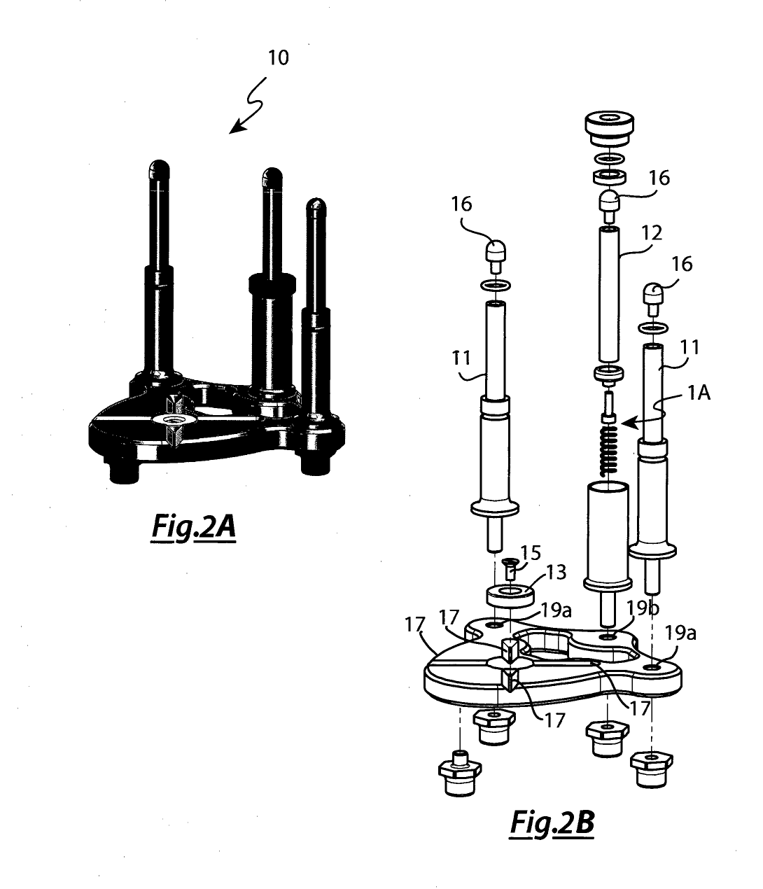

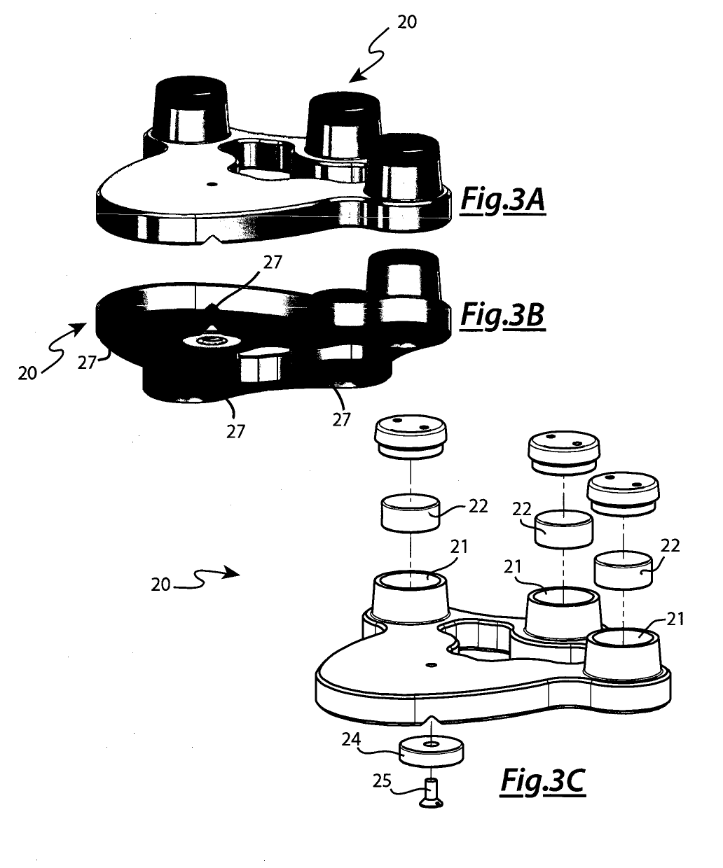

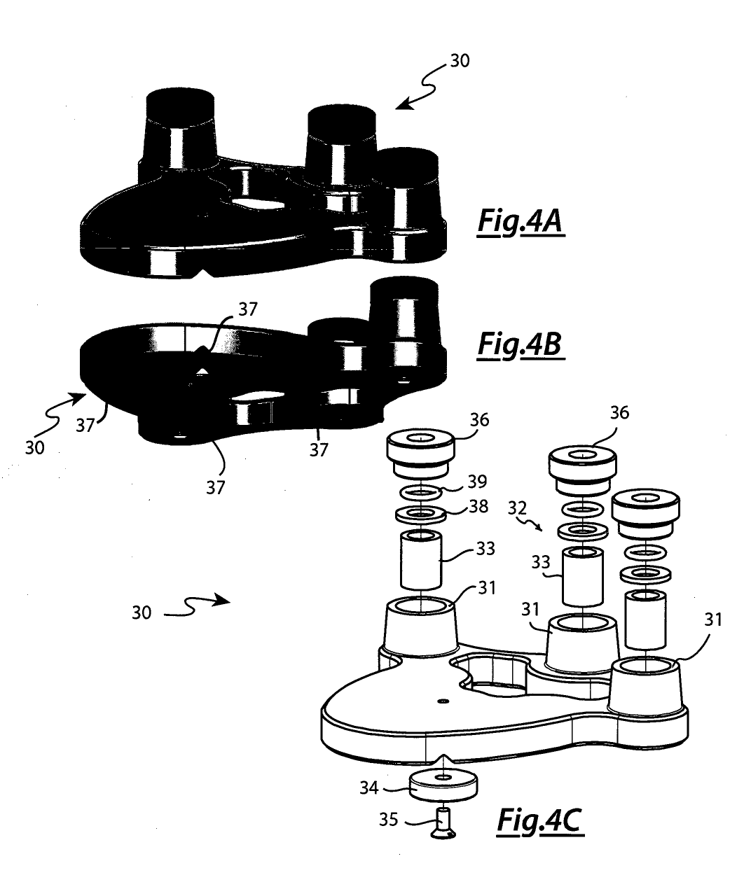

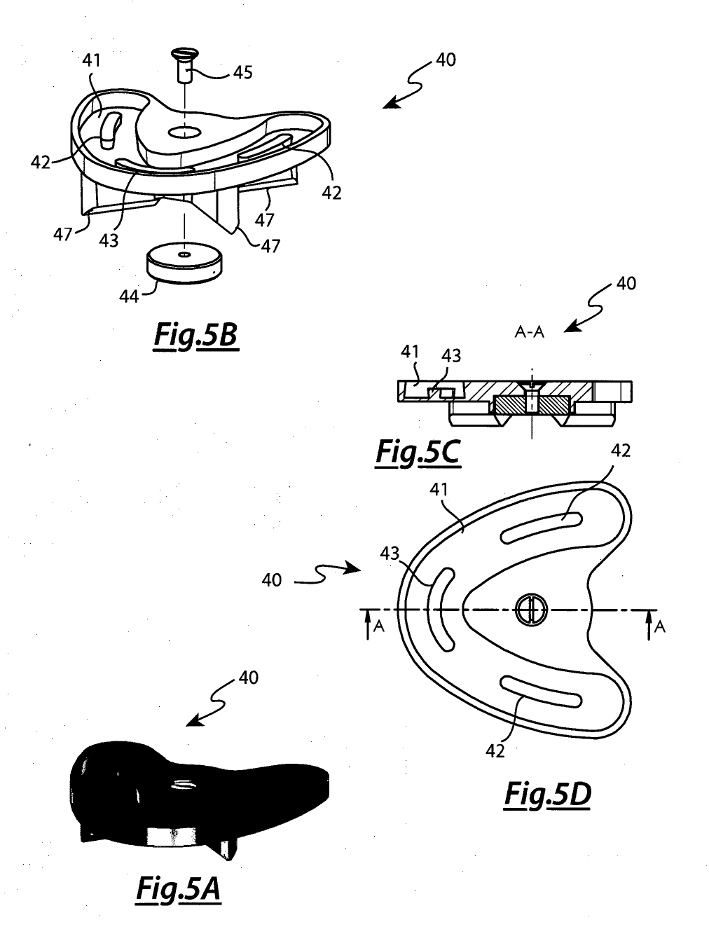

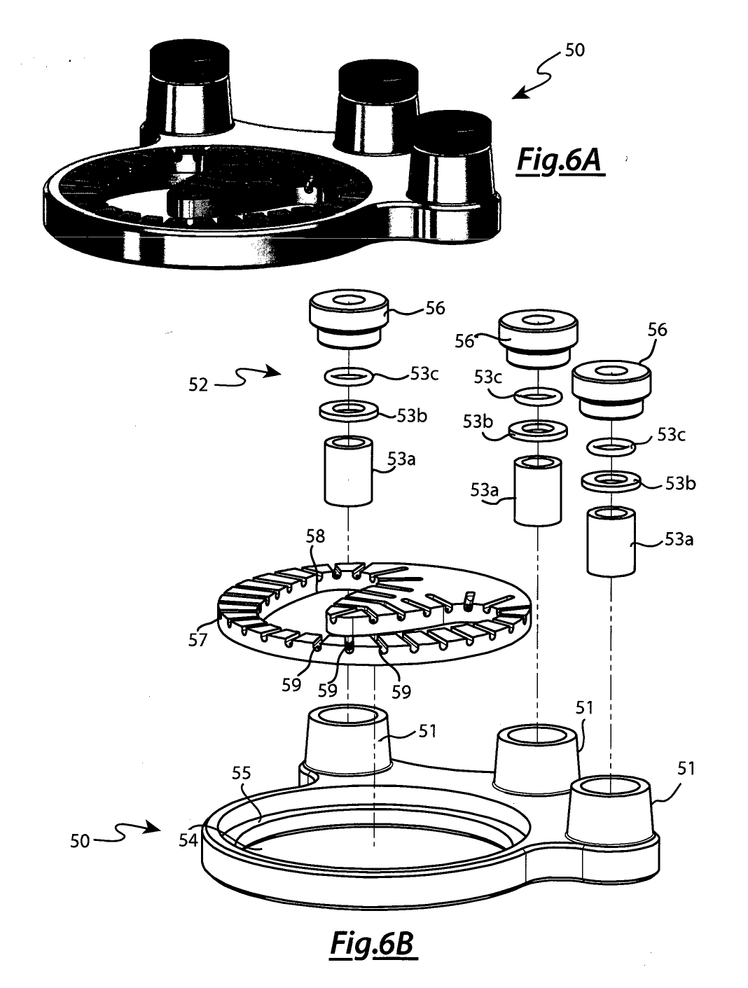

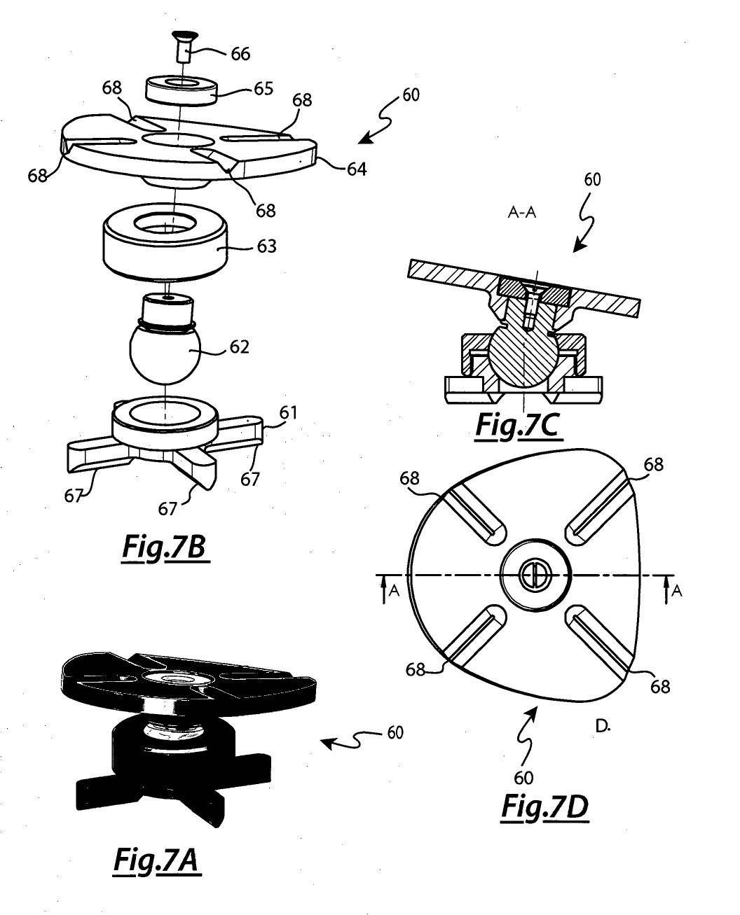

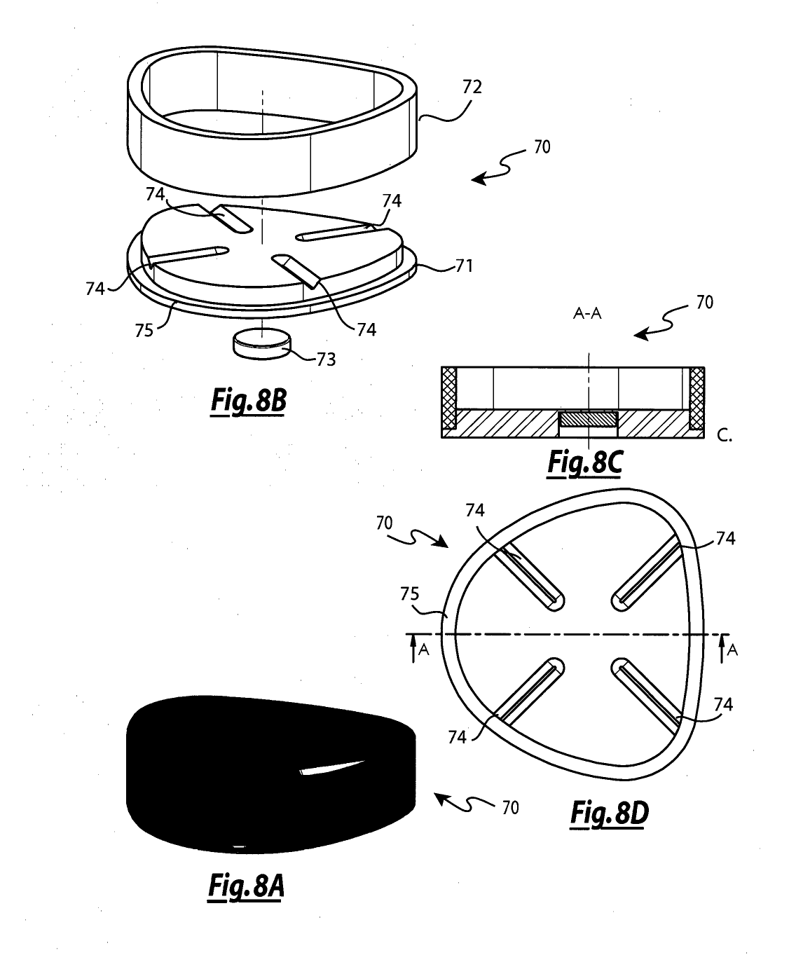

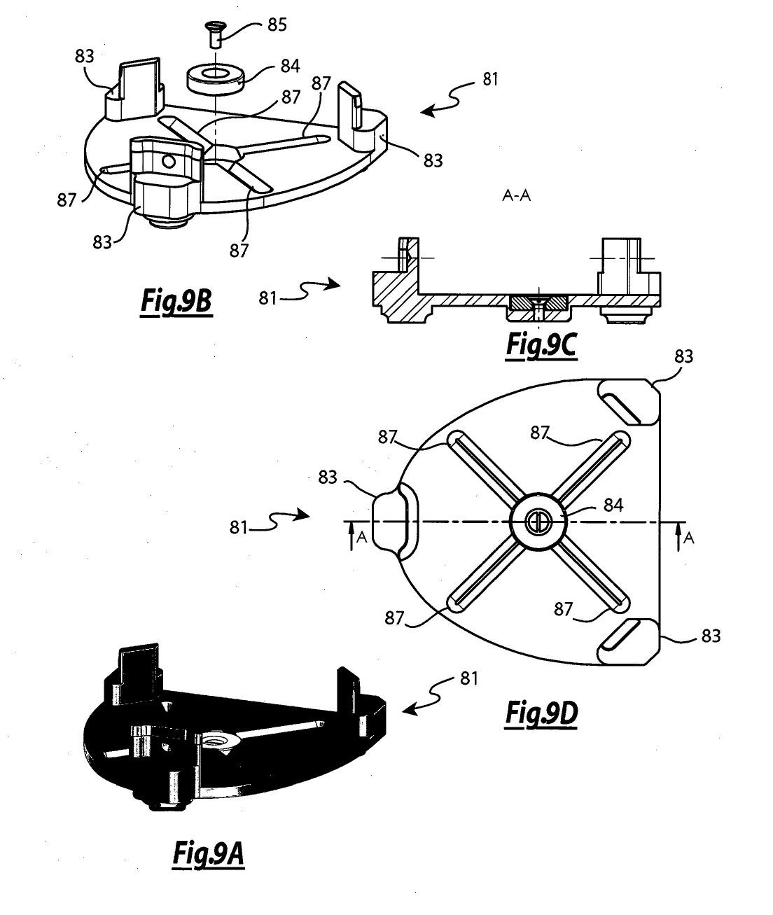

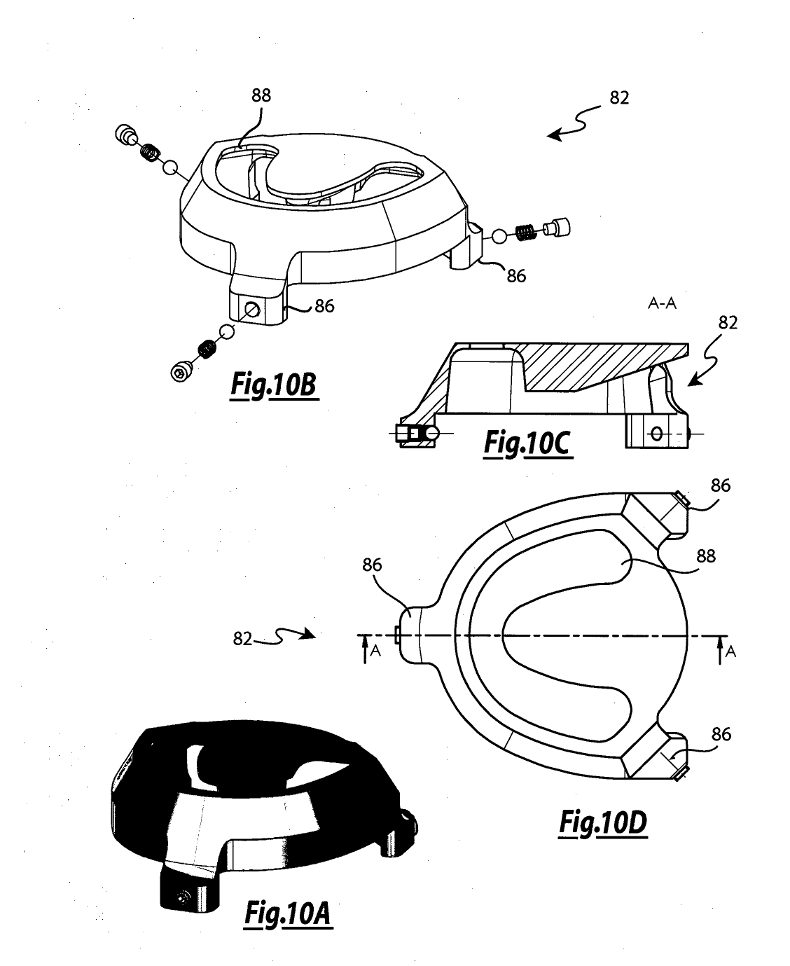

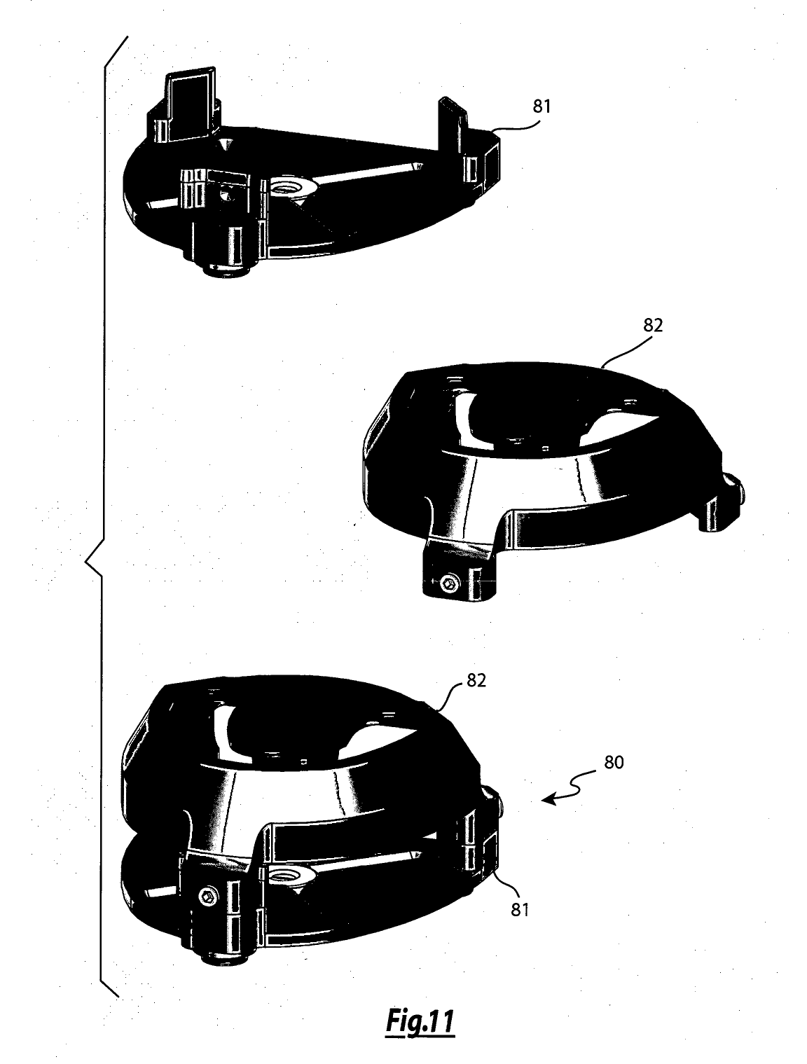

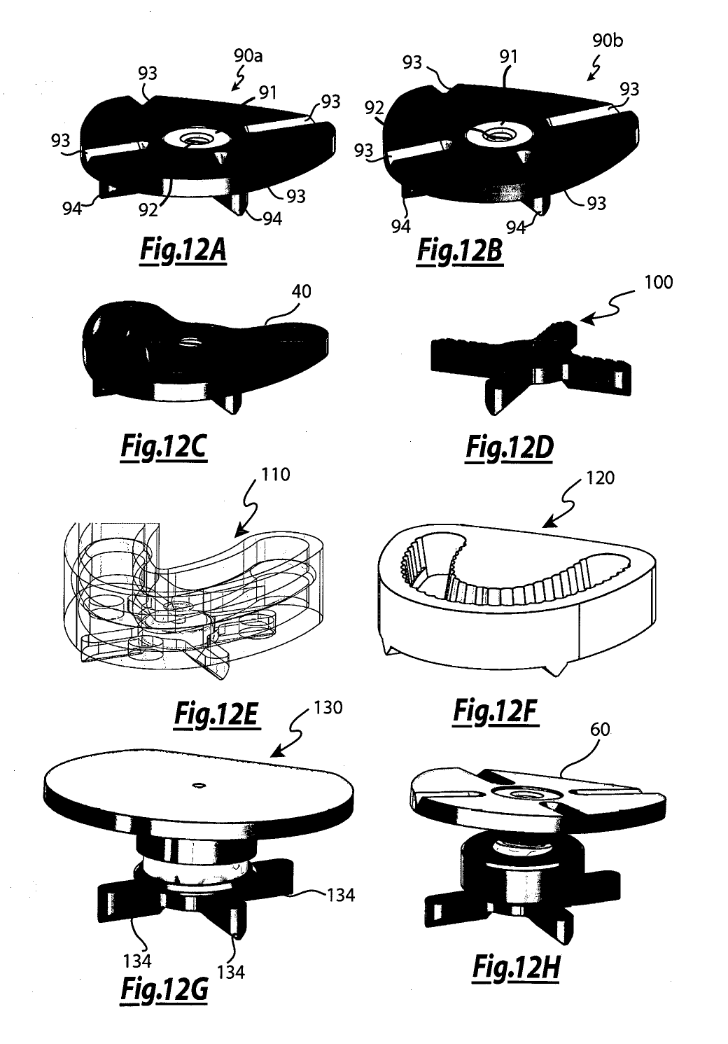

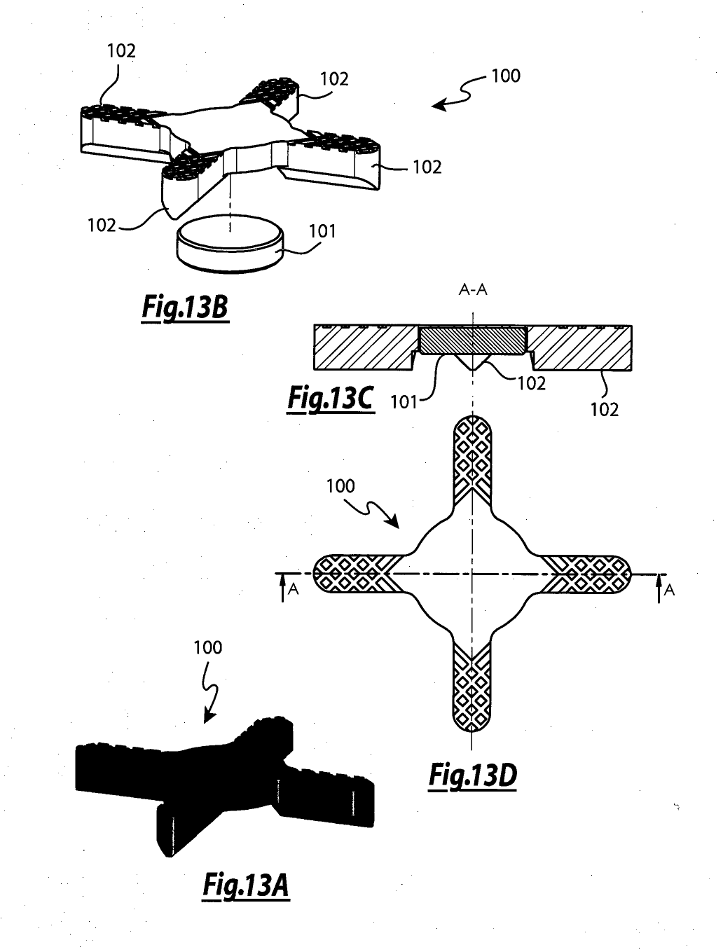

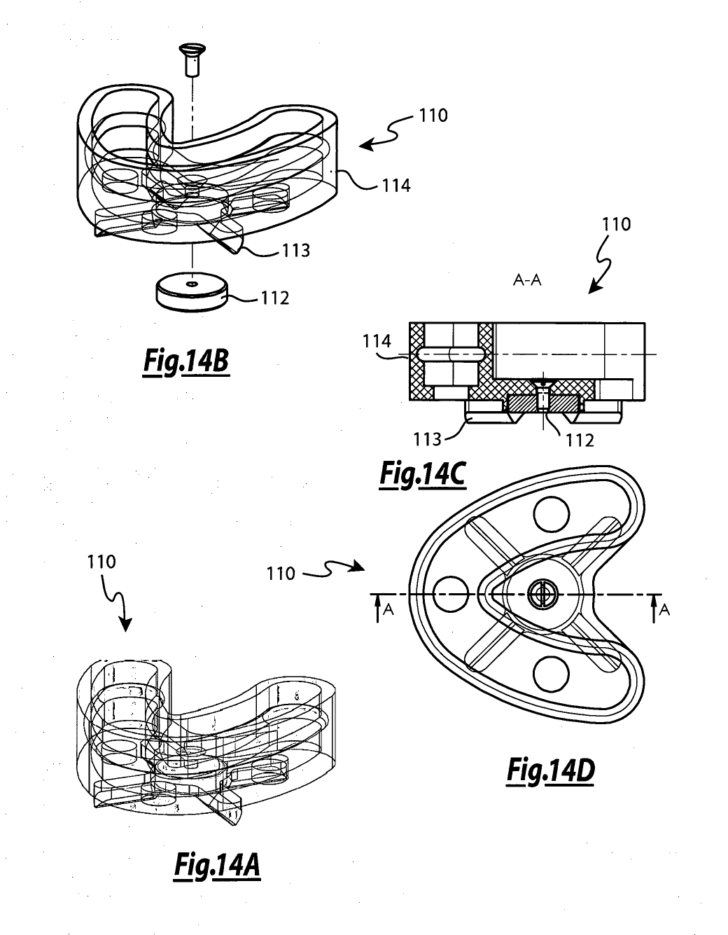

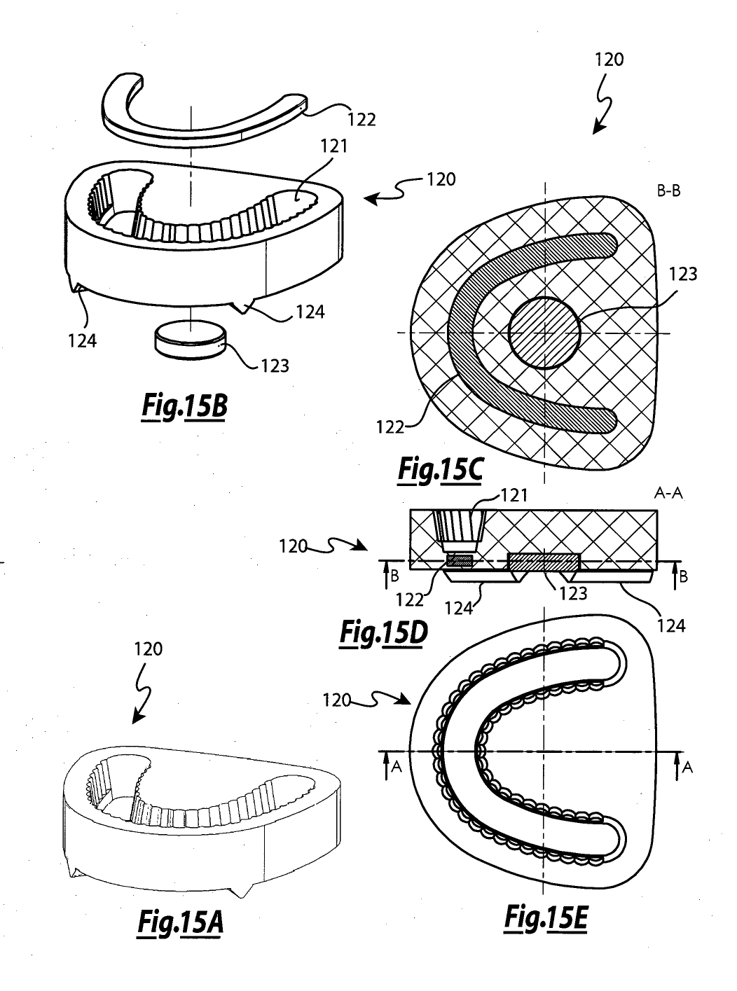

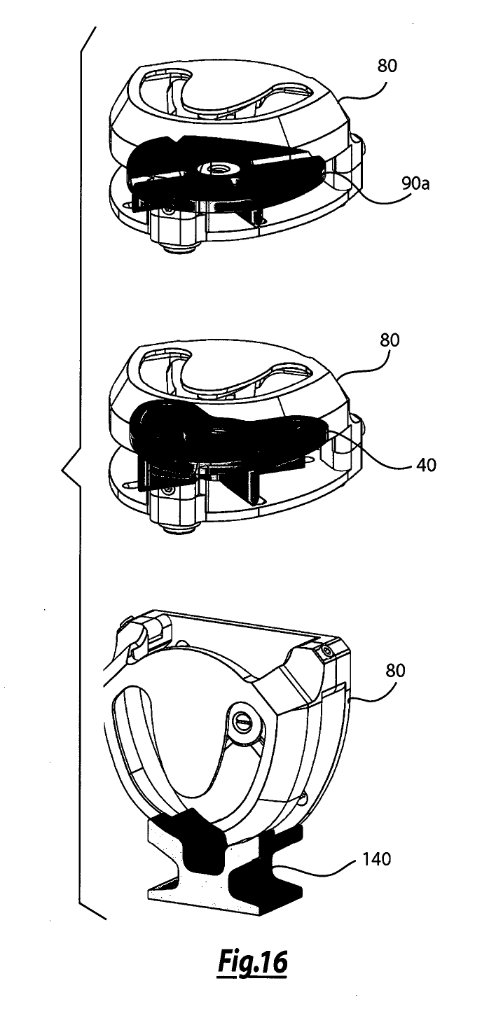

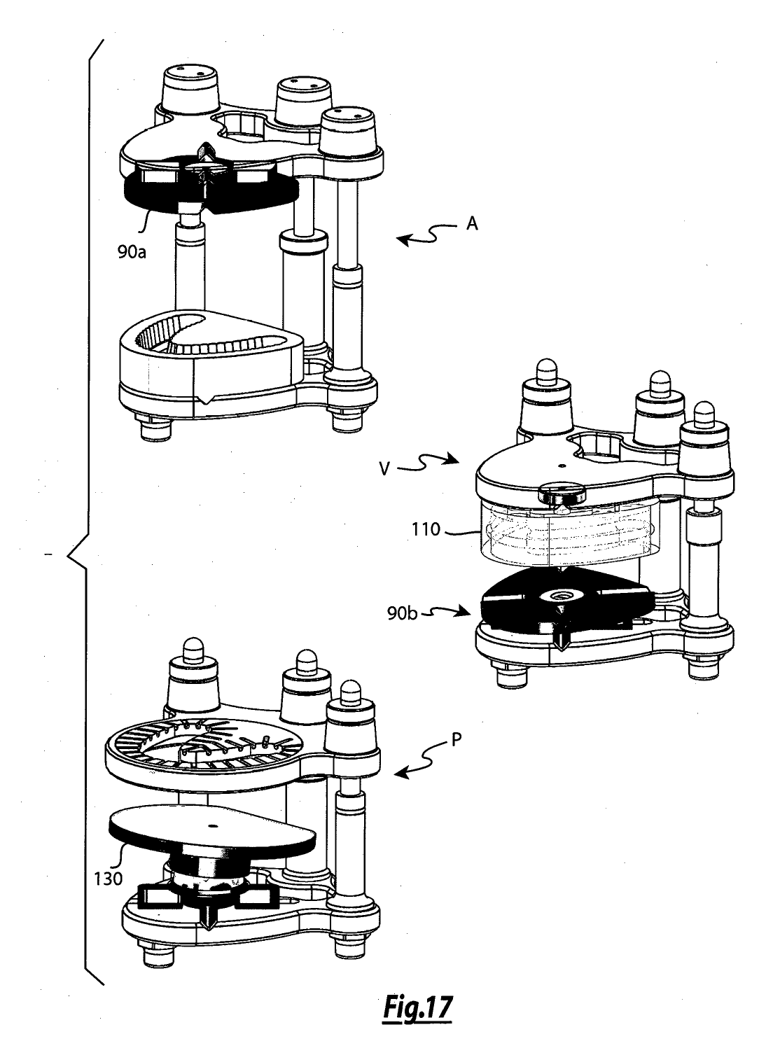

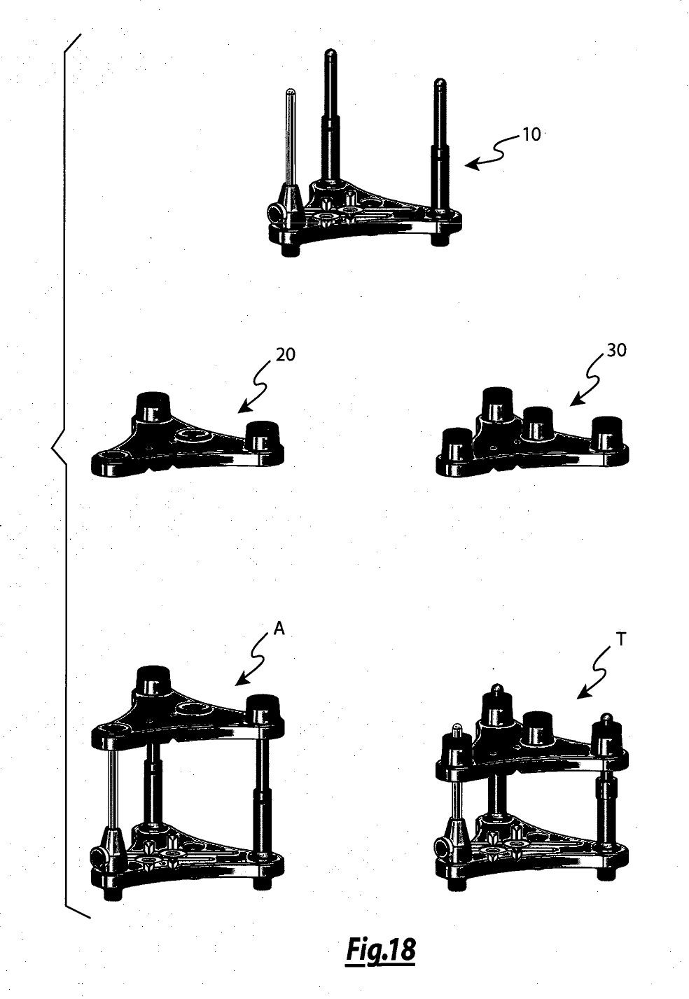

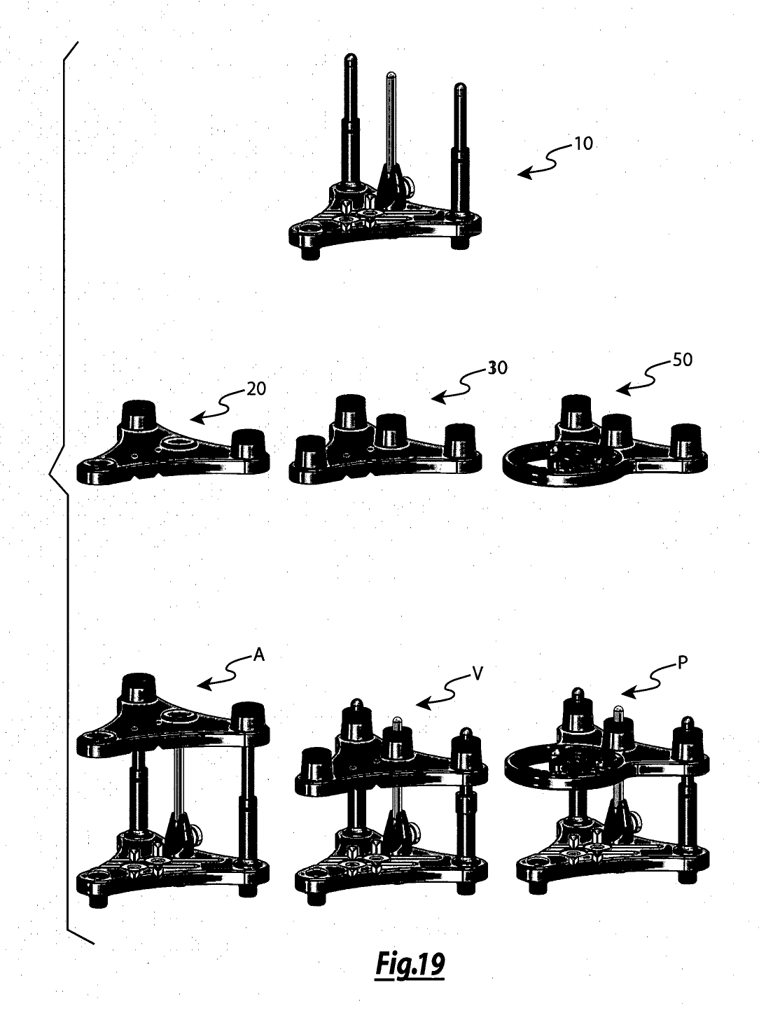

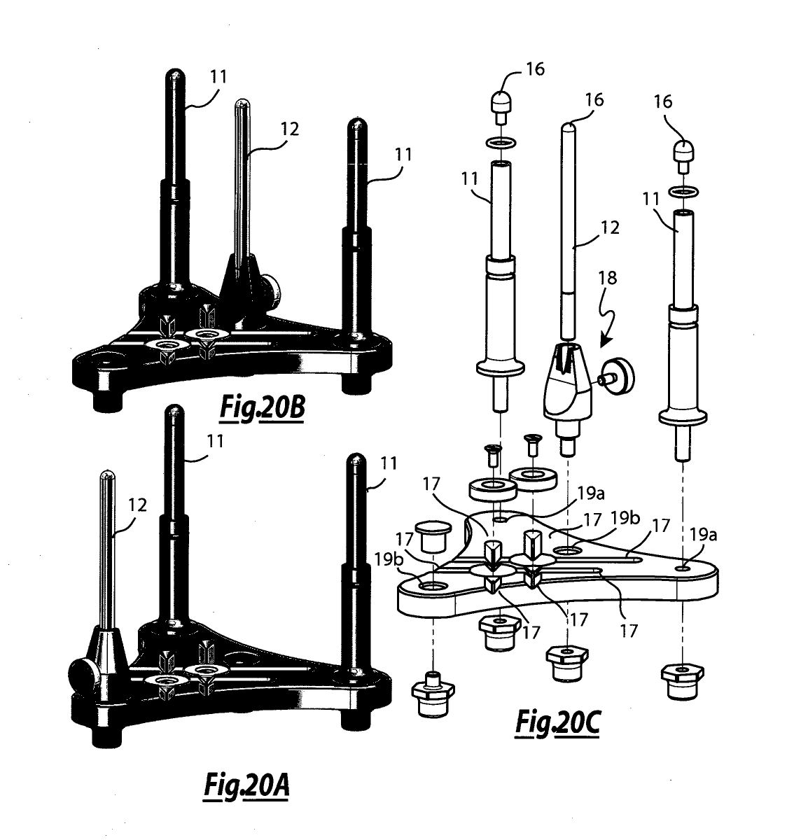

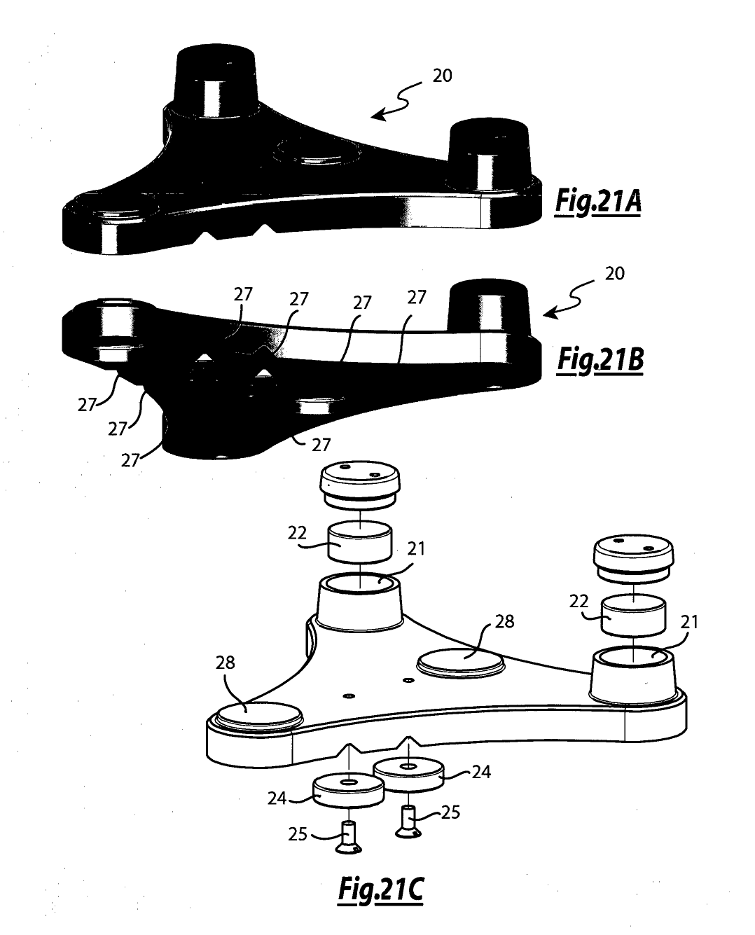

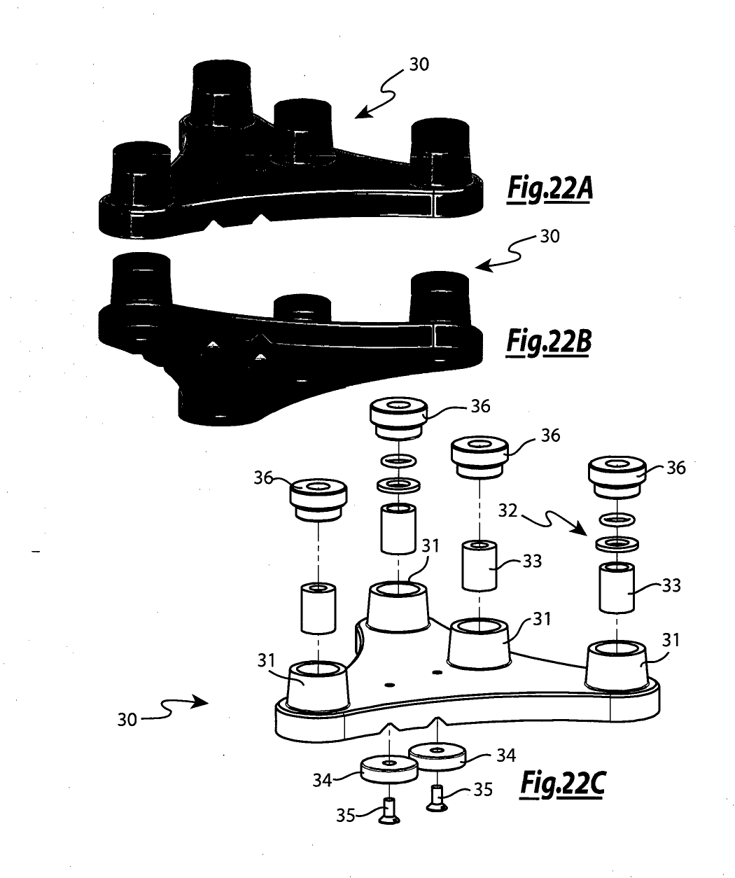

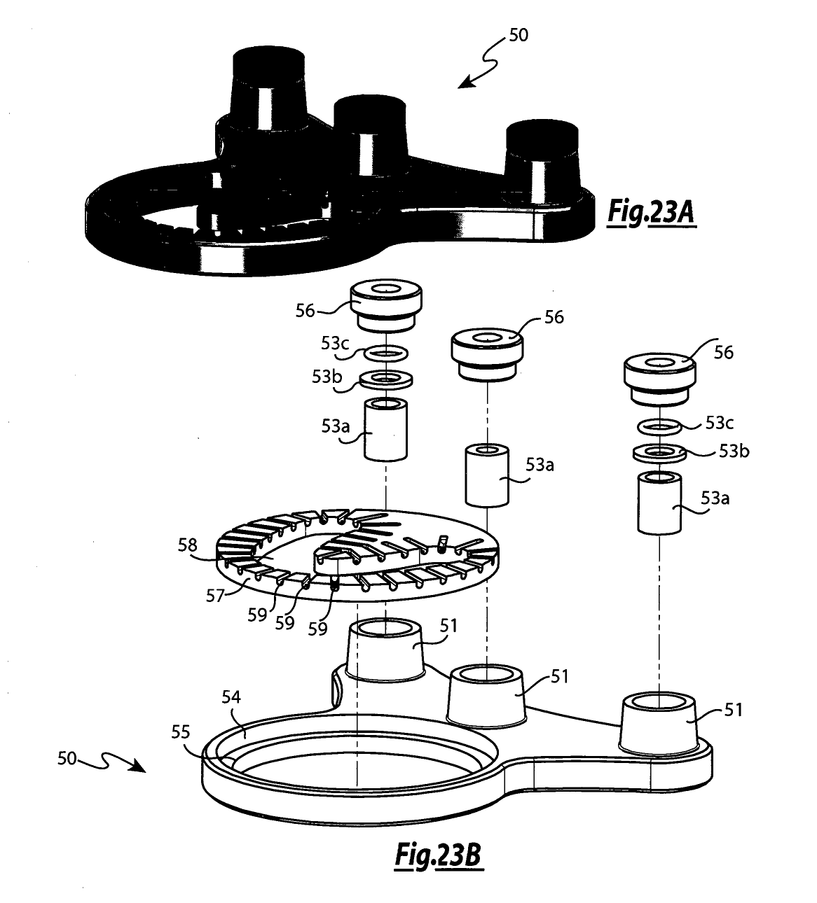

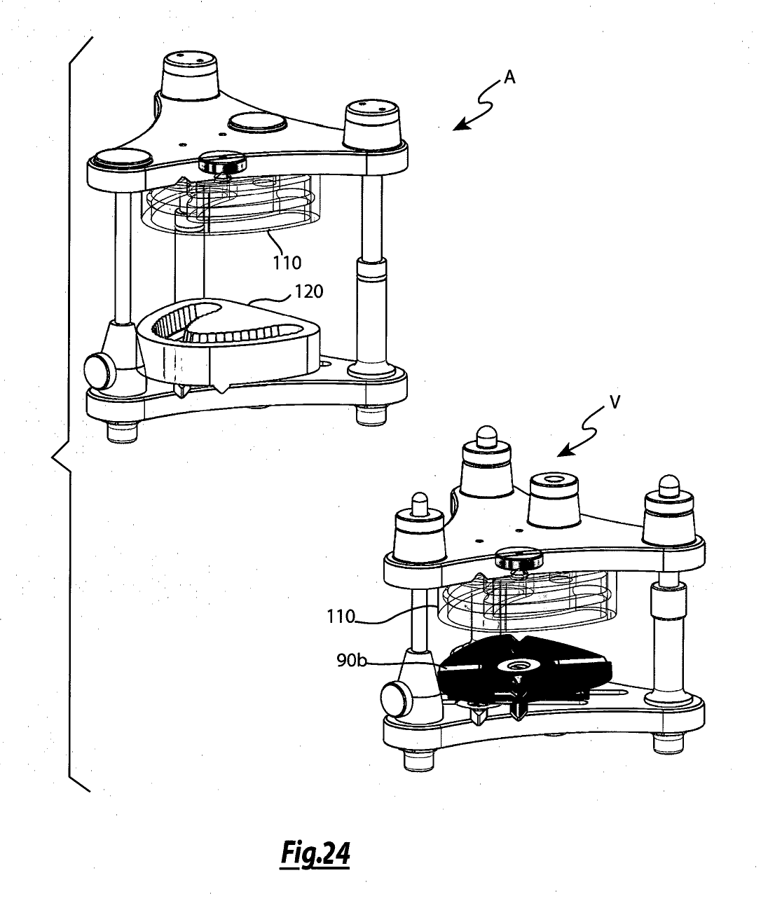

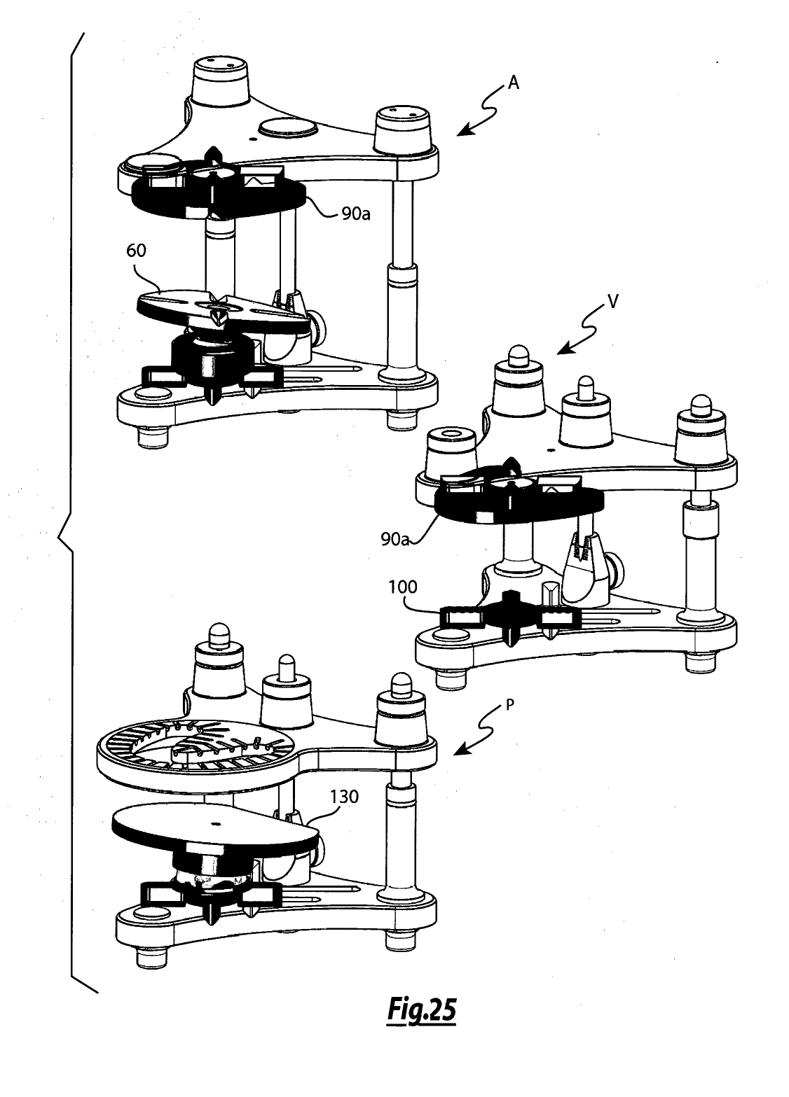

a base element 10, an articulator lid 20, a verticulator lid 30, a plate 40 for silicone mask, a positioning lid 50, a mould 70, a mitten 80, a plate 90a of splitex type, an inclined plate 90b of splitex type, a splitex type plate 40 for silicone mask, a universal support 100, a transparent box 110, a support 120 for the model with removable abutments, a balancing support 130 and a lockable balancing support 60. In particolar,
the possible combinations of the basic elements of the supporting structure according to the invention are shown in an isometric view in FIG. 1;
an assonometric view in A and an exploded view in B of the base element of the support structure according to the invention are shown in FIG. 2;
an assonometric view from the top in A, an assonometric view from the bottom in B and an exploded view in C of the verticulator lid of the support structure according to the invention are shown in FIG. 3;
an assonometric view from the top in A, an assonometric view from the bottom in B and an exploded view in C of the verticulator lid of the support structure according to the invention are shown in FIG. 4;
an assonometric view from the top in A, an exploded view in B, a section view in C and a top view in D of the plate for silicone mask of the support structure according to the invention are shown in FIG. 5;
an assonometric view in A and an exploded view in B of the positioning lid of the support structure according to the invention are shown in FIG. 6;
an isometric view from the top in A, an exploded view in B, a section view in C and a top view in D of the lockable balancing support of the support structure according to the invention are shown in FIG. 7;
an assonometric view from the top in A, an exploded view in B, a section view in C and a top view in D of the mould of the support structure according to the invention are shown in FIG. 8;
an assonometric view from the top in A, an exploded view in B, a section view in C and a top view in D of the joint base of the mitten of the support structure according to the invention are shown in FIG. 9;
an assonometric view from the top in A, an exploded view in B, a section view in C and a top view in D of the joint lid of the mitten of the support structure according to the invention are shown in FIG. 10;
the assembly of the base and lid of the mitten of the assembly according to the invention is shown in FIG. 11;
the main interchangeable accessories of the support structure according to the invention are shown in FIGS. 12A-12H;
an assonometric view from the top in A, an exploded view in B, a section view in C and a top view in D of an universal accessory of the support structure according to the invention are shown in FIG. 13;
an assonometric view from the top in A, an exploded view in B, a section view in C and a top view in D of the transparent box of the support structure according to the invention are shown in FIG. 14;
an assonometric view from the top in A, an exploded view in B, a section view in C and D and a top view in E of the support for model with removable fragments of the support structure according to the invention are shown in FIG. 15;
various combinations of the mitten of FIGS. 9, 10 and 11 with one of the interchangeable accessories of FIGS. 12A-12H are shown in FIG. 16, according to a preferred embodiment;
various combinations of the instruments of FIG. 1 with one of the is interchangeable accessories of FIGS. 12A-12H are shown in FIG. 17, according to a preferred embodiment;
the possible combinations of the basic elements of the support structure according to the invention, are shown in an assonometric view in FIG. 18, in a further preferred embodiment;
an assonometric view of the possible combinations of the basic elements of the support structure according to the invention is shown in FIG. 19, in a further preferred embodiment;
an assonometric view in A and B with two different possible positions of the adjustment rod and an exploded view in C of the base element are shown in FIG. 20, in a further preferred embodiment of the support structure according to the invention;
an assonometric view from the top in A, an assonometric view from the bottom in B and an exploded view in C of the articulator lid are shown in FIG. 21 in a further preferred embodiment of the support structure according to the invention;
an assonometric view from the top in A, an assonometric view from the bottom in B and an exploded view in C of the verticulator lid are shown in FIG. 22, in a further preferred embodiment of the support structure according to the invention;
an assonometric view in A and an exploded view in B of the positioning lid are shown in FIG. 23, in a further preferred embodiment of the support structure according to the invention;
various combinations of the instruments of FIG. 18 with one of the interchangeable accessories of FIGS. 12A-12H are shown in FIG. 24, according to a preferred embodiment, and
various combinations of the instruments of FIG. 19 with one of the interchangeable accessories of FIGS. 12A-12H are shown in FIG. 25, according to a preferred embodiment.

With reference to FIGS. 1, 18 and 19, the support structure according to the invention includes a base element 10, which can be coupled with the lids 20, 30, 50, whose coupling system will be explained below.

From the coupling of the base element 10 with one of the lids 20, 30, 50, a dental articulator A, a dental verticulator V and a dental positioning element P are respectively obtained.

With reference to FIGS. 2 and 20, three rods are coupled with the base element 10: two front rods 11 positioned in the seats 19a and an adjusting rod 12, that can fit in at least one seat 19b, substantially between the two front rods 11, or at the back. In addition, the base element 10 is equipped with at least one punched magnet 13 and related fastening screw 15. Four grooves 17 radially arranged around each of at least one central magnet 13 are placed on the upper surface of the base element 10. In a preferred embodiment, illustrated in FIG. 2, the rear rod 12 is provided with a cushioning system 14 that allows, with a slight pressure, to simulate the mastication passing through the opening position to the closing one. All the rods present at the top a spherical end 16, which can be made magnetic. The rods 11, 12 consist of two cylinders of different base diameter, the upper part having a diameter smaller than the lower part, so that the vertical movement of an element, having some holes in the positions corresponding to the rods 11, 12, is limited to the height of the upper part of the rods 11, 12. FIG. 2 shows the possibility to insert a spacer hood 18 into the side rods. During any working of the model, it is necessary to overturn the aid tools on which it is mounted, until everything becomes unstrung from the base. For this reason, an O-ring (not shown in the figure) in inserted into the bottom of the rods 11, 12, at about 5 mm from their top, that allows the seal and locking of the spacer hood 18. Such a cap, not shown in the figures, can have different thicknesses and has the function to create a greater space between the lid and the model, when necessary.

In a further preferred embodiment, shown in FIG. 20, the rear rod 12 is provided with an adjustment system 18, consisting of a base and a screw. Also, two seats 19b are present on the base which can be alternatively used in order to position the rod 12, depending on the working needs.

With reference to FIGS. 3 and 21, the articulator lid 20 presents at the back at least two spherical caps 21, preferably milled at an angle of 30°, in a position corresponding and facing the seats 18, 19 of the rods 11, 12. Magnets 22 are inserted inside the caps 21. These magnets allow coupling of the articulator lid 20 with the spherical ends 16 of the rods 11, 12 of the base element 10, since the articulator lid 20 faces the base element 10 and can therefore be coupled with it by precision, thus constituting a dental articulator A shown in FIGS. 1, 18 and 19. In its lower face, facing the base element 10, the articulator lid 20 is provided with at least one punched central magnet 24 and related fastening screw 25 and presents four grooves 27 radially arranged around each at least one central magnet 24 and corresponding and facing the grooves 17 radially arranged on the base element 10.

In a preferred embodiment, illustrated in FIG. 3, the spherical shape of the caps 21 allows a total freedom of the rotary motions, at 360° on all the planes passing through the centre of the spheres. In the partial reconstructions, the dental articulator A thus obtained adapts to the inclinations of the remaining teeth which drive it. The absence of a rod at the front position on the base allows a total view of the model.

In a preferred embodiment, illustrated in FIG. 21, there are provided two first caps 21 for the two rods 11 and two second caps 28, which can be used alternatively on the basis of the position of the rod 12, in one or the other seat 19b, established from time to time depending on the working needs.

Referring to FIGS. 4 and 21, at least three through holes 31 are made in the verticulator lid 30 corresponding to the three rods 11, 12 of the base element 10. In this way, the holes 31 allow the verticulator lid 30 to couple with the base element 10, since the verticulator lid 30 faces the base element 10 and can thus be coupled with the latter by precision and it is free to move vertically, thus forming a dental verticulator V shown in FIGS. 1, 18 and 19. Advantageously, the holes 31 are each equipped with a self-lubricating mechanism 32 that allows a vertical quiet and precise sliding. Preferably, the mechanism 32 comprises a bushing or washer 33, a spacer 38, an O-ring 39 and a punched plug 36 which can be screwed. By screwing and unscrewing the plug 36 it is possible to adjust the flow of the verticulator lid 30 on the rods 11, 12, until the total block in the desired position.

Moreover, since during certain working of the model it is necessary to overturn the aid tools on which it is mounted, without all the accessories become unstrung from the base, the O-ring 39 is inserted into the lower thicker part of the rod 11 and the plug or cap 36 inserts into the O-ring 39 so as to remain thus stuck.

Once made the model, it is possible with a simple act to remove the articulator lid 20 and insert the verticulator lid 30, thus obtaining a verticulator V shown in FIGS. 1, 18 and 19.

In its lower side, facing the base element 10, the verticulator lid 30 is provided with at least one punched central magnet 34 and related fastening screw 35 and has four grooves 37 radially arranged around each of at least one central magnet 34 and corresponding and facing the four grooves 17 radially arranged on the base element 10.

As far as FIG. 5 is concerned, the splitex type plate 40 for silicone mask has in its lower face a cavity 41 with an undercut along the semicircle, two side marker steps 42 and a central step 43, necessary for retaining the silicone mask. Such a cavity 41 and steps 42, 43 form a retaining system that allows to get a single body comprising the plate 40 and the mask, so as to totally eliminate the risk of inaccuracy due to the necessary insertion and extraction of the mask to/from its support during normal working. In its upper side, facing the verticulator lid 30, the plate 40 is equipped with a punched central magnet 44 and related fastening screw 45 and has four projections 47 radially situated around the central magnet 44 and corresponding and facing the four grooves 37 radially arranged on the verticulator lid 30 with which it can be coupled.

Referring to FIGS. 6 and 23, three bushings 51 corresponding to the three rods 11, 12 of the base element 10 and a central circular hole 54, having a step 55 made along its edge, are present on the positioning lid 50. A circular plate 57 having the dimensions of the hole 54 is supported on the step 55. The circular plate 57 presents a horseshoe bat recess 58 and slots 59 radially arranged, perpendicular to the edge of the bat recess 58, along its perimeter. In this manner, the bushings 51 allows the positioning lid 50 to be coupled with the base element 10, since the positioning lid faces the base element 10 and can thus be coupled with it by precision and it is free to move vertically, thus forming a dental positioning element P shown in FIGS. 1, 19.

Advantageously, the holes 51 are each equipped with a self-lubricating mechanism 52 that allows a vertical quiet and precise sliding. Preferably, the mechanism 52 includes a sleeve 53a, a spacer 53b, an O-ring 53c and a punched plug 56 which can be screwed. By screwing and unscrewing the plug 56 it is possible to adjust the flow of the positioning lid 50 on the rods 11, 12, until the total lock in the desired position.

Moreover, since during certain working of the model it is necessary to overturn the aid tools on which it is mounted, without all the accessories become unstrung from the base, the O-ring 53c is inserted into the lower thicker part of the rod 11 and the plug or cap 56 inserts into the O-ring 53c so as to remain thus stuck.

Relating to FIG. 7, the lockable balancing support 60 consists of a support 61, a ball 62, a locking ring 63 of the ball 62, a lockable balancing plate 64, a punched magnet 65 and related fastening screw 66. The support 61 has four projections 67 radially arranged around the ball 62 and corresponding and facing the four grooves 17 radially arranged on the base element 10, with which it can be coupled. In its upper side, facing the verticulator lid 30, the balancing plate 64 has four grooves 68 radially arranged around the central magnet 65 and corresponding and facing the four grooves 17 radially arranged on one of the lids 20 or 30.

Referring to FIG. 8, the mould 70 is constituted by a plate 71, a rubber ring 72 and a central magnet 73. The plate 71 has a depressed step 75 along the entire profile and four grooves 74 radially arranged around the centre and corresponding and facing the four grooves 17 radially arranged on the base element 10. The mould has the function to create the shoe of each model, so that it can precisely be positioned at an exact point corresponding to all the instruments object of the invention.

Referring to FIGS. 9, 10 and 11, the mitten 80 is composed of a base 81 and a lid 82. The base 81 presents at the angles three guides 83, a punched central magnet 84 and related fastening screw 85 and has four grooves 87 radially arranged around the central magnet 84 and corresponding and facing the four grooves 27, 37 radially arranged on the lids 20, 30. The lid 82 is substantially cap-shaped and presents at the angels three joints 86 which correspond and can be coupled to the guides 83. The upper surface presents an horseshoe opening 88 of the same sizes of the bat recess 58 of the positioning lid 50. It is clear that the mitten 80, thus constituted, allows to perform all the types of transformation of the prosthesis, such as for example casting, injection and pressing.

In relation to FIGS. 12A-12H, 13, 14 and 15, the possible accessories for the instruments described above are a plate 90a of splitex type, an inclined plate 90b of splitex type, a splitex type plate 40 for silicone mask, a universal support 100, a transparent box 110, a support 120 for the model with removable abutments, a balancing support 130 and a lockable balancing support 60.

The plate 90a and inclined plate 90b are provided each with a central punched magnet 91 and related fastening screw 92 and present in the upper surface four grooves 93 arranged radially around the central magnet 91 and corresponding and facing the four grooves 37 arranged radially on one of the lids 20 or 30. They also present on the lower surface four projections 94 placed radially around the central magnet 91 and corresponding to the four grooves 17 arranged radially on the base element 10, with which they can be coupled. The universal support 100 is constituted by a central part 101 which can be magnetized and four spokes 102 corresponding to the four grooves 17 arranged radially on the base element 10, with which they can be coupled. Such a universal support 100 can be used to couple with the instruments (A, V, P), mitten 80, plates 90a and 90b and balancing support 60 any additional object not provided by the present invention. The transparent box 110 presents inferiorly a magnetic central part 112 and four spokes 113 corresponding to the four grooves 17 arranged radially on the base element 10, with which they can be coupled, and superiorly a horseshoe transparent container 114. The support 120 for the model with removable abutments superiorly presents a horseshoe hole 121, on the bottom of which a shaped magnet 122 is placed, and inferiorly a central magnet 123 and four spokes 124 corresponding to the four grooves 17 arranged radially on the base element 10, with which they can be coupled.

Relating to FIG. 16, the mitten 80 can be coupled with a splitex type plate 90a, 40, with or without silicone mask, or can be placed on the proper support 140.

As far as FIG. 17 is concerned, the base element 10 can be provided for example with inclined plate 90b, balancing support 60, 130, or support 120 for model with removable fragments. Plates 40, 90a, 90b of various heights can be coupled with the dental articulator A. a transparent box 110 can be coupled with the verticulator V. In this way, since a plate 40 is coupled with the base element 10, with built-in model, it is possible to inject some silicone or composite resins inside the cavity which has been created between the box 110, the built-in model and the mask of the plate 40. In order to replace the transparent box 110, and move to new workings on the mask, it is sufficient to detach it from the verticulator lid 30 and fix another accessory.

As far as FIGS. 24 e 25 are concerned, the base element 10 can be provided for example with inclined plate 90b, support 120 for the model with removable fragments, balancing support 60 or 130 or universal support 100 which can be used to position any other accessory not provided by the present invention.

For example, a transparent box 110 or a plate 90a, 90b or 40 can be coupled with the dental articulator A and verticulator V. Since a support 120 for model with removable fragments is coupled with the base element 10, it is possible to inject some silicone or composite resins inside the cavity which has been created between the box 110 and the model with removable fragments in the support 120. in order to replace the transparent box 110, and moving to new workings on the mask, it is sufficient to detach it from one of the lids 20 o 30 and fix another accessory.

The model of metallic structure, for example of “Toronto” type, dug-out and arranged for milling, can be fixed onto the balancing support 60, 130 which can be locked. The balancing support 60, 130 allows to place the model in such a way as to it is perfectly parallel to the upper plane of the positioning lid 50. By lowering the positioning lid 50 along the rods 11, 12, the model inserts into the horseshoe bat recess 58 of the circular plate 57. Locking is possible through the system 52. By inserting some metallic wires into the slots 59 of the circular plate 57, it is possible to make the metallic structure integral with an auto-polymerizing resin or a composite resin. In order to work the structure thus obtained, it is sufficient to unscrew the locking system 52 and detach the balancing support 60 from the base.

The present invention has been described by illustrative, but not limiting, way according to its preferred embodiments, but it has to be understood that changes and/or modifications could be done by the men skilled in the art without for this reason going out of the related scope of protection, as defined by the appended claims.

1. Support structure to make instruments for dental prosthesis, comprising a base element (10), a plurality of upper elements (20, 30, 50) which are coupled, through guide means (11, 12), with said base element (10), and positioning means (21, 31 , 51) placed on each of said upper elements (20, 30, 50), one or more handmade articles need to make a dental prosthesis being assembled upon instruments (A, V, P) resulting from said coupling, characterized in that said guide means include at least two first rods (11), which are placed in first relative seats (19a), said seats (9a) being made along a perimeter portion of said base element (10), and at least one third rod (12), which is placed in at least one second relative seat (19b), said at least one second seat (19b) being located substantially adjacent or opposite to the minimum perimeter portion of said base element (10) between said first seats (19a).

2. Support structure as claim 1, characterized in that said at least one second seat (19b) is located in a position which is substantially in the middle between said first seats (19a).

3. Support structure as in claim 1, characterized in that said third rod (12) has an elastic damping system (14), which allows, by means a light pressure, to simulate mastication by passing from an open position to a closed position.

4. Support structure as in claim 1, characterized in that said third rod (12) has an adjustment system (18), preferably consisting of a base and an adjustment screw.

5. Support structure as in claim 1, characterized in that said positioning means (21) include at least two caps for supporting and guiding said rods (11, 12).

6. Support structure as in claim 1, characterized in that said positioning means (21) are internally provided with first coupling means (22), preferably magnets, which correspond to second coupling means (16), preferably magnetized ends, positioned at the top of said rods (11, 12).

7. Support structure as in claim 1, characterized in that said positioning means (31, 51) include at least three holes made on said upper elements (30, 50).

8. Support structure as in claim 1, characterized in that said positioning means (31) are each provided with a self-lubricating vertical sliding mechanism (32).

9. Support structure as in claim 1, characterized in that said positioning means (31) are each provided with a locking bushing (33) and/or with a punched and screwing plug (36).

10. Support structure as in claim 1, characterized in that said structure comprises a Splitex plate (40) for a silicone mask, which has a cavity (41) in its lower face with an undercut along the semicircle and one or more marker steps (42), said cavity (41) and said one or more steps (42) forming a sealing system that allows to form a single body comprising said plate (40) and said mask.

11. Support structure as in claim 1, characterized in that said structure comprises a pivoting support (60, 130) including a support (61), a ball (62), at least one ring (63) for locking said ball (62) and at least one lockable pivoting plate (64).

12. Support structure as in claim 1, characterized in that said structure comprises finishing fittings (40, 60, 80, 90A, 90B, 100, 10, 120, 130) coupled with said instruments (A, V, P) and interchangeable through first coupling means (13, 24, 34), preferably magnets, placed on said base element (10) and on said upper elements (20, 30), and second coupling means (44, 65, 73, 84, 91, 101, 112, 123), preferably magnetized disks, placed on said finishing fittings (40, 60, 80, 90A, 90B, 100, 110, 120, 130).

13. Support structure as in claim 1, characterized in that said structure includes finishing fittings (40, 60, 80, 90A, 90B, 100, 110, 120, 130) coupled with said instruments (A, V, P) and interchangeable through first positioning means (17, 27, 37), preferably facing and corresponding grooves, which are provided on said base element (0) and on said upper elements (20, 30), and second positioning means (47, 67, 87, 94, 102, 113, 124, 134), preferably projections facing and corresponding to said grooves, which are provided on said finishing fittings (40, 60, 80, 90A, 90B, 100 110, 120, 130).

14. Support structure as in claim 1, characterized in that said structure comprises finishing fittings (40, 60, 80, 90A, 90B, 100, 110, 120, 130) coupled to each other and interchangeable by means of first positioning means (68, 87, 93), preferably grooves facing and corresponding with each other, which are provided on said finishing fittings (60, 80, 90A, 90B), and second positioning means (47, 67, 87, 94, 102, 113, 124, 134), preferably facing projections corresponding to said grooves, which are provided on said finishing fittings (40, 60, 80, 90A, 90B, 100, 110, 120, 130).

15. Support structure as in claim 1, characterized in that said structure comprises a multipurpose element (100), which has a second coupling means (101), preferably a magnetic disk, corresponding to said first coupling means (13, 24, 34) provided on said instruments (A, V, P), and/or having second positioning means (102) corresponding to said first positioning means (17, 27, 37) which are provided on said instruments (A, V, P), so that any other finishing fittings can be coupled.

16. Support structure as in claim 1, characterized in that said structure comprises a mold (70) to make a base of each prosthetic handmade article needed for processing a dental prosthesis, so that said base is coupled with said instruments (A, V, P) and with related finishing fittings (60, 80, 90A, 90B), through first positioning means (17, 27, 37, 68, 87, 93), preferably facing and corresponding grooves, and second positioning means, preferably protrusions facing and corresponding to said grooves, which are provided on said base.

17. Support structure as in claim 11, characterized in that said first positioning means (17, 27, 37, 68, 87, 93) comprise essentially cross-shaped four grooves and said second positioning means (47, 67, 87, 94, 102, 113, 124, 134) comprise substantially cross-shaped four projections, which correspond to said grooves.

18. Support structure as in claim 12, characterized in that said first positioning means (17, 27, 37, 68, 87, 93) comprise essentially cross-shaped four grooves and said second positioning means (47, 67, 87, 94, 102, 113, 124, 134) comprise substantially cross-shaped four projections, which correspond to said grooves.

19. Support structure as in claim 13, characterized in that said first positioning means (17, 27, 37, 68, 87, 93) comprise essentially cross-shaped four grooves and said second positioning means (47, 67, 87, 94, 102, 113, 124, 134) comprise substantially cross-shaped four projections, which correspond to said grooves.
